(19) United States
(12) Patent Application Publication
(10) Pub. No.: US 2022/0244952 A1
(43) Pub. Date: Aug. 4, 2022

(54) SOURCE CODE GENERATION USING CODE TEMPLATES WITH NEURAL TRANSFORMERS

(71) Applicant: MICROSOFT TECHNOLOGY LICENSING, LLC., Redmond, WA (US)

(72) Inventors: MIKHAIL BRESLAV, REDMOND, WA (US); COLIN BRUCE CLEMENT, SEATTLE, WA (US); DAWN DRAIN, BELLEVUE, WA (US); CHANGRAN HU, BERKELEY, CA (US); NEELAKANTAN SUNDARESAN, BELLEVUE, WA (US); CHEN WU, BEIJING (CN)

(21) Appl. No.: 17/219,886

(22) Filed: Apr. 1, 2021

Related U.S. Application Data
(60) Provisional application No. 63/144,451, filed on Feb. 1, 2021.

(51) Int. Cl. G06F 8/73; G06N 3/08; G06F 8/36; G06F 16/9032

(52) U.S. Cl. CPC G06F 8/73; G06F 16/90332; G06F 8/36; G06N 3/084

(57) ABSTRACT

A source code generation system uses a neural transformer model with attention to predict candidate method bodies given a method docstring, method signature, and one or more method templates. The method templates are derived from intent-snippet pairs from StackOverflow question/answer pairs or template methods from GitHub. Joint embeddings are generated for the method bodies of the method templates and associated method docstrings for quick retrieval. A code completion system uses the source code generation system to generate candidate method bodies to complete a method signature and/or method docstring using the method templates.

### CROSS-REFERENCE TO RELATED APPLICATIONS

The present application claims the benefit of the earlier filed provisional application having Ser. No. 63/144,451 filed on Feb. 1, 2021, which is incorporated by reference in its entirety.

### BACKGROUND

Software development environments are often used to aid software developers (i.e., users, programmers, etc.) to develop program code. The software development environment may include a source code editor and other tools that a developer utilizes to write and test their programs. Some software development environments include a code completion feature that provides assistance while the developer is editing code by automatically presenting a list of possible candidates based on one or more characters (e.g., letters, symbols, etc.) that a developer has typed into a source code editor. A popup menu may appear with several suggested code elements that the developer may utilize. This assistance is beneficial since it speeds up the development time and reduces common errors, such as typos.

However, the automatic code completion feature may be problematic when the code completion system does not recognize an out-of-vocabulary code element, requires a lot of memory, takes too long to generate a list of candidates, and/or generates a list of candidates that are not relevant.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A source code generation system produces source code method bodies using a neural transformer with attention (“model”) and method templates. The source code generation system receives a query, a method signature and one or more method templates closely-related to the query and uses the neural transformer model with attention, given the query, method signature and method templates, to predict a method body.

A method template is obtained from publicly-available sources such as StackOverflow intent/snippet (i.e., query/answer) pairs and GitHub method templates. A method template includes a method docstring, a method signature and a method body. Joint embeddings are made for the intent/snippet pairs or the method docstring/method template pairs of a method so that a search technique can find a query that is close to the method template.

In one aspect, the source code generation system is used for code completion. As a developer is developing a method in a source code development tool, the source code generation system extracts the method docstring as the query to find pre-existing method templates. The retrieved method templates, method docstring and method signature are then applied to the neural transformer model with attention to predict method bodies that are presented to the developer.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 illustrate an exemplary source code generation system that uses a neural transformer with attention to predict a source code method body.

FIG. 2 is a schematic diagram illustrating an exemplary encoder-decoder configuration of a neural transformer model with attention.

FIG. 3 is a flow diagram illustrating an exemplary method of the source code generation system.

FIG. 4 is a flow diagram illustrating an exemplary method for training and generating the components of the source code generation system.

FIG. 5 is a flow diagram illustrating an exemplary method for training the neural transformer with attention.

FIG. 6 is a flow diagram illustrating an exemplary method of the source code generation system for predicting candidate method bodies.

FIG. 7 is a flow diagram illustrating an exemplary method for using the neural transformer model with attention in a beam search to predict candidate method bodies.

FIG. 8 is a schematic diagram illustrating usage of the source code generation system for code completion.

FIG. 9 is a schematic diagram illustrating an exemplary method template retrieved for the source code snippet shown in FIG. 8.

FIG. 10 is a block diagram illustrating an exemplary operating environment.

FIG. 11 is a schematic diagram illustrating the training of the query and method template encoder.

### DETAILED DESCRIPTION

### Overview

A source code generation system generates source code method bodies using a neural transformer with attention and method templates. The neural transformer model with attention predicts candidate method bodies given a query, a method signature and one or more method templates.

A neural Bag-of-Words (“NBoW”) bi-encoder is used to train a method template encoder to generate embeddings for method templates and a query encoder to generate embeddings for a query. A code search engine uses the query embedding to search a method template database for an associated method template based on closely-matching method template embeddings.

In one aspect, the source code generation system is used for code completion. As a developer is developing a method in a source code development tool, the source code generation system extracts the method docstring as the query to find pre-existing method templates based on an associated query embedding. The method templates, method docstring and method signature are then applied to the neural transformer model with attention to predict candidate method bodies that are presented to the developer.

Attention now turns to a further description of the systems, devices, methods for automated code generation.

Code Generation System

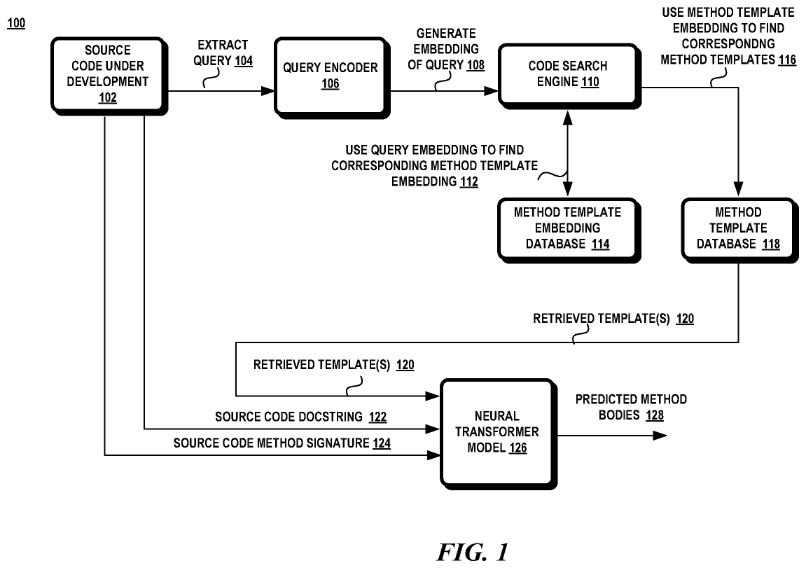

FIG. 1 illustrates an exemplary system 100 for code generation. Referring to FIG. 1, the system 100 includes a query encoder 106, a code search engine 110, a method template embedding database 114, a method template database 118, and a neural transformer model with attention 126.

In one aspect, the system 100 interacts with a source code program under development 102 in a source code editor, integrated development environment, or other software development tool. The query encoder 106 receives a query for a predicted source code method body. In one aspect, the query consists of the docstring of a method under development or alternatively, a method signature of the method under development if no method docstring exists. A method docstring is a string literal in a source code program used to document a particular segment of code. A method signature consists of the method name and the parameters of the method. The method body is the source code statements that implement the method excluding the method signature and method docstring.

A query encoder 106 generates an embedding of the query 108 which is then used by a code search engine 110 to search for a method template embedding in the method template embedding database 114. In one aspect, the code search engine 110 uses a nearest neighbor search technique to find a method template embedding closest to the query embedding 112. The method template embedding is then used to find one or more method templates 116 from the method template database 114 corresponding to the query.

The neural transformer model with attention 126 is then utilized to predict one or more method bodies for the query 104. The neural transformer model with attention 126 is given the method docstring 122, the method signature 124 and the retrieved method templates 120.

In some situations, there may not be a method docstring or the method docstring is poorly written or misleading. In such situations, the method signature is used as the query and the neural transformer model with attention only receives the method signature 124 and the retrieved method templates 120.

Neural Transformer Model Architecture

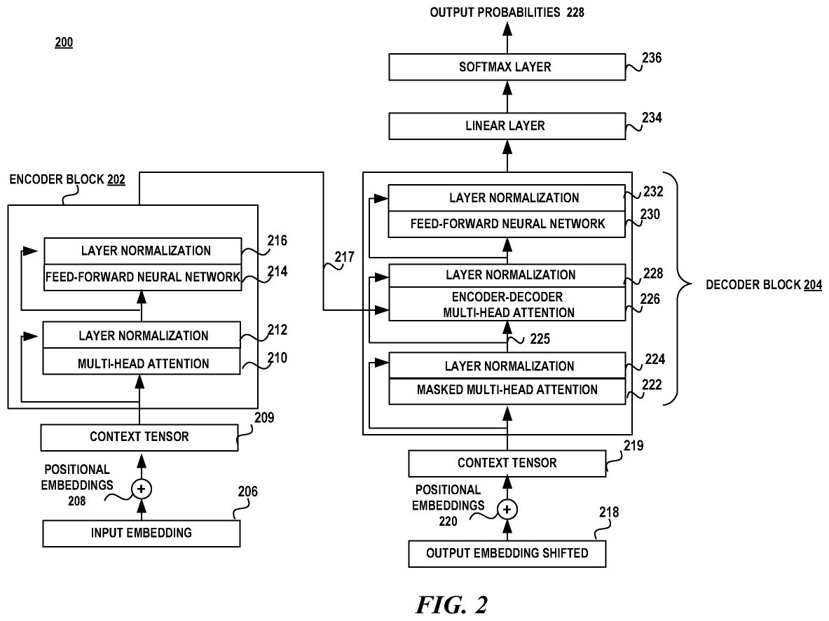

FIG. 2 shows an exemplary architecture of the neural transformer model with attention. A neural transformer with attention is one distinct type of machine learning model. Machine learning pertains to the use and development of computer systems that are able to learn and adapt without following explicit instructions, by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The attention mechanism provides the model with a better capability to learn the task at hand thereby generating more accurate predictions of the candidate method bodies.

The neural transformer model 200 contains one or more encoder blocks 202 coupled to one or more decoder blocks 204. The initial inputs to an encoder block 202 are the input embeddings 206 of an input sequence of a training dataset. In order to retain the order of the tokens in the input embedding 206, positional embeddings 208 are added to the input embedding 206 forming a context tensor 209. The initial inputs to the decoder block 204 are a shifted sequence of the output embeddings 218 from a previous time step to which the positional embeddings 220 are added forming context tensor 219.

An encoder block 202 consists of two layers. The first layer includes a multi-head attention component 210 followed by layer normalization component 212. The second layer includes a feed-forward neural network 214 followed by a layer normalization component 216. The context tensor 209 is input into the multi-head attention component 210 of the first encoder block 202 with a residual connection to the layer normalization component 212. The output of the layer normalization component 212 is input to the feed-forward neural network 214 with another residual connection to layer normalization component 216. The output of the encoder block 202 is a set of hidden representations 217. The set of hidden representations 217 is then sent through additional encoder blocks. At the last encoder block, the set of hidden representations 217 is sent to the decoder 204.

Attention is used to decide which parts of the input embedding are important for each token, especially when decoding long sequences since the encoder is limited to encoding a fixed-size vector. Attention mechanisms gather information about the relevant context of a given token and then encode that context into a vector which represents the token. It is used to identity the relationships between tokens in the long sequence while ignoring other tokens that do not have much bearing on a given prediction.

The multi-head attention component 210 takes a context tensor 209 and weighs the relevance of each token represented in the context tensor 209 to each other by generating attention weights for each token in the input embedding 206. In one aspect, the attention function is scaled dot-product attention which is described mathematically as follows:

$$Attention ( Q , K , V ) = softmax ( \frac{Q {K}^{T}}{\sqrt{{d}_{k}}} ) V ,$$

where the input consists of queries Q and keys K of dimension dₖ, and values V of dimension dᵥ. Q is a matrix that contains the query or vector representation of one token in a sequence, K is the vector representations of all tokens in the sequence, and V is the vector representations of all the tokens in the sequence.

The queries, keys and values are linearly projected h times in parallel with dᵥ output values which are concatenated to a final value:

MultiHead(Q, K, V)=Concat(head₁, . . . , headhₕ) W^{o},

where headᵢ=Attention(QWᵢ^{Q}, KWᵢ^{K}, VWᵢ^{V}),

with parameter matrices Wᵢ^{Q}ϵ [symbol] ^{d}^{_{model}}^{×d}^{ₖ}, Wᵢ^{K}ϵ [symbol] ^{d}^{_{model}}^{×d}^{ₖ}, Wᵢ^{V}ϵ [symbol] ^{d}^{_{model}}^{×d}^{ₖ}, and W^{o}ϵ [symbol] ^{hd}^{ᵥ}^{×d}^{_{model}}.

In order to reduce the training time of the neural transformer, layer normalization is used between the layers. The layer normalization components 212, 216 normalize the inputs across the features. The mean and standard deviation is computed across the feature dimensions.

The feed-forward neural network 214 processes each output encoding separately. The output of the top encoder block is a set of attention vectors K and V 217 which is used by the encoder-decoder multi-head attention layer 226 of the decoder block 204.

The decoder block 204 predicts each token tᵢ in the target programming language one-by-one at each time step conditioned on all previously-generated target tokens t₁, . . . tᵢ₋₁. A decoder block 204 consists of three layers. The first layer includes a masked multi-head attention component 222 followed by a layer normalization component 224. The output of the layer normalization component 225 is input into the encoder-decoder multi-head attention component 226 with a residual connection to layer normalization component 228. The second layer includes an encoder-decoder multi-head attention component 226 followed by a layer normalization component 228. The third layer includes a feed-forward neural network 230 followed by a layer normalization component 232. The output of layer normalization component 228 is input into the feed-forward neural network 230 with a residual connection to layer normalization component 232.

The masked multi-head attention component 222 receives the output embeddings of the previous timestep. The masked multi-head attention component 222 masks the output embeddings from future time steps. The encoder-decoder multi-head attention layer 222 receives queries from the previous decoder layer and the memory keys and values 217 from the output of the encoder block 202. In this manner, the decoder block 204 can attend to every position of the input sequence. The feed-forward neural network 230 processes each output encoding separately. A layer normalization component 224, 228, 232 is used between the layers in order to normalizes the inputs across the features.

In one aspect, the neural transformer model contains a stack of six encoder blocks and a stack of six decoder blocks which are aggregated into a neural transformer block. The output of each encoder block is passed onto the next encoder block and processed. Each decoder block receives the attention weights computed from the last encoder block. The use of multiple stacked encoder blocks and decoder blocks increases the model's capacity allowing the model to learn increasing levels of abstraction.

Attention now turns to description of the various exemplary methods that utilize the system and device disclosed herein. Operations for the aspects may be further described with reference to various exemplary methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

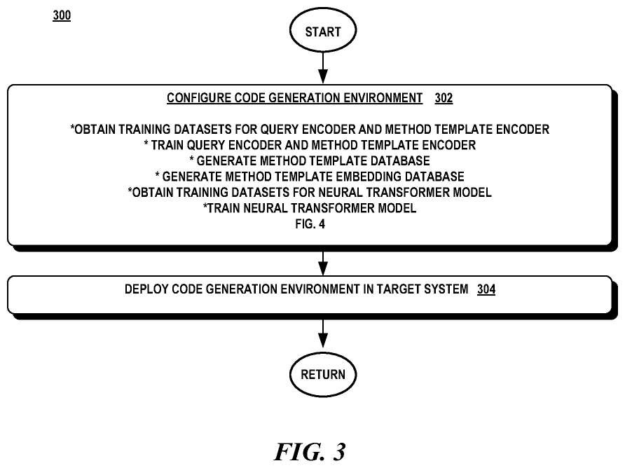

Turning to FIG. 3, there is shown an exemplary process 300 for generating a code generation system and deploying the system in a target source code development environment. Initially, the training datasets are generated for the query encoder, method template encoder and neural transformer model and used to train the neural components (block 302). In addition, various sources are used to extract data for the method template database. The method template encoder is used to generate the indices of the method template embedding database (block 302). The code generation system is then deployed in a target software development environment (block 304).

Training

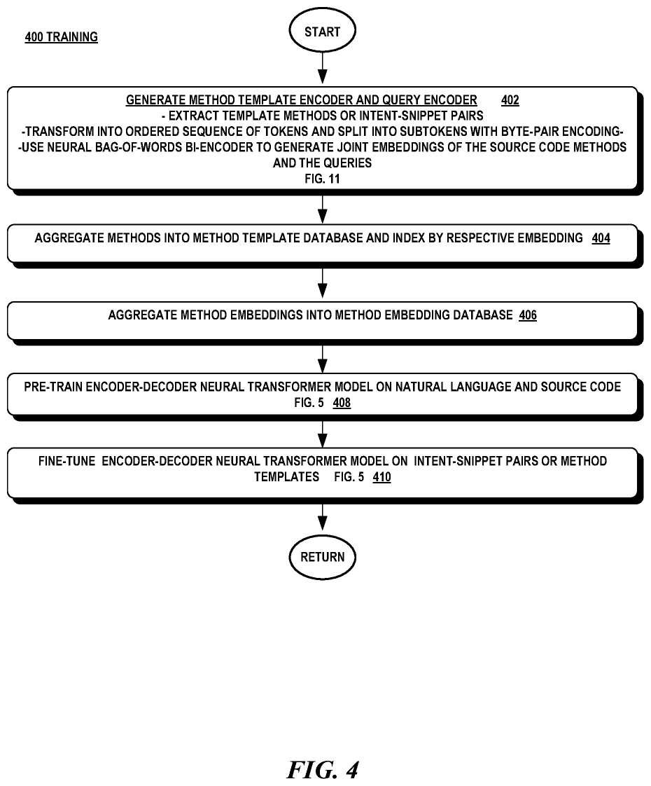

Turning to FIG. 4, there is shown an exemplary process 400 for generating the various components of the source code generation system.

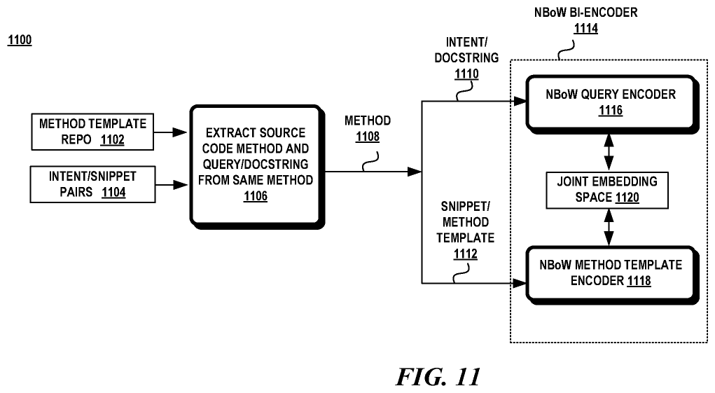

Initially, the query encoder and method template encoder are trained from training datasets extracted from various sources. The query encoder and the method template encoder are trained to map queries and methods into a single, joint embedding space. In this manner, source code and natural language are mapped into embeddings that are relatively close to each other so that the embeddings can be used in a search. The search method uses an embedding of the query to find embeddings of source code methods that are near each other in the embedding space. Attention now turns to FIG. 11 which illustrates a more detailed discussion of the training of the query encoder and the method template encoder to generate a joint embedding space of the query embeddings and the method template embeddings. (Collectively, block 402).

Turning to FIG. 11, there is shown a neural bag-of-words (NBoW) bi-encoder 1114 including a NBoW query encoder 1116 and a NBoW method template encoder 1118. The query encoder 1116 generates an embedding for a query and the method template encoder 1118 generates an embedding for method templates. The query encoder 1116 and the method template encoder 1118 are jointly trained using query/method template pairs that are extracted from the same method 1106, 1108.

Each NBoW encoder learns an embedding for each token in isolation and produces a sequence embedding for a query/method template pair by averaging the token embeddings of the pair. In one aspect, a fusion representation is used to average the token embeddings into a single vector using mean-pooling, max-pooling, and a self-attention type of weighted average with learnable weights thereby generating a joint embedding space 1120. A learnable linear layer is added to the method template encoder to align the code embedding space with the query embedding space.

This joint embedding is generated by minimizing the loss function of the encoders as follows:

$$\frac{1}{N} {Σ}_{i} log ( \frac{{exp ( {E}_{c} ( {c}_{i} ) )}^{T} {E}_{q} ( {d}_{i} ) )}{{Σ}_{j} {exp ( {E}_{c} {c}_{j} )}^{T} {E}_{q} ( {d}_{i} ) )} ) , \qquad$$

where there are N pairs of query/method template pairs (cᵢ, dᵢ), where cᵢ is the source code method template, dᵢ is the associated natural language text, E_{c} is the method template encoder, and E_{q} is the query encoder.

In one aspect, a training dataset for the query encoder and the method template encoder consist of intent-snippet pairs 1104 from the Code/Natural Language Challenge (“CoNaLa”) dataset or source code methods 1102 from a method repository, such as the GitHub template function repository. The CoNaLa dataset is constructed from answer/response pairs of Python code from the StackOverflow website. The intent is the title of the StackOverflow question in natural language text 1110 and the snippet 1112 is the source code method that implements the intent. The intent portion 1110 of an intent-snippet pair is parsed into an ordered sequence of tokens that are split using byte-pair encoding and input into the NBoW query encoder 1116 for the encoder to learn embeddings of the subtokens in the intent.

The snippet portion 1112 of the intent-snippet pair is parsed into an ordered sequence of tokens that are split using byte-pair encoding and input into the NBoW method template encoder 1118 for the encoder to learn embeddings of the subtokens in source code snippet. It should be noted that the terms token and subtoken are used interchangeably.

In another aspect, method templates from a method template repository 1102 are obtained and used as the training dataset. A method template contains a docstring, method signature and method body of a method. The method docstring portion of the method template is parsed into an ordered sequence of tokens that is split using byte-pair encoding and input into the NBoW query encoder 1116 for the encoder to learn embeddings of the subtokens in the docstring. The source code portion of the method template which includes the method signature and the method body is parsed into an ordered sequence of tokens that are split using byte-pair encoding and input into the NBoW method template encoder 1118 for the encoder to learn embeddings of the subtokens in the method template.

Turning back to FIG. 4, the snippet portion of the intent-snippet pairs or the source code portions of the method templates are input into a method template database and indexed by the respective method template embedding (block 404). The method embeddings are aggregated into the method embedding database (block 406).

The neural transformer model is pre-trained on natural language text and source code of a target programming language. The model is then fine-tuned on method signatures and method docstrings to learn to predict the source code of a corresponding method body. Initially, the neural transformer model is trained on natural language text, such as English language text. Alternatively, the neural transformer model may be obtained from a pre-existing source having been already trained on a natural language text (Collectively, block 408).

In one aspect, the order in which the pre-training component trains the neural transformer model is performed by pre-training on the English corpus first and then subsequently pre-training on source code programs. The pre-training on the English corpus first allows the model to learn semantic relationships between words. The subsequent pre-training on source code programs is intended to specialize the model on source code, aiming at learning syntactical properties of the programming language, while retaining semantic knowledge. (Collectively, block 408).

In one aspect, the natural language is English language text. A diverse corpus of unlabeled English text, derived from various sources (e.g., Wikipedia, webtext, and books) is used to obtain sequences of English-language text. A byte-level byte-pair extraction component generates T-ordered sequences of subtokens from each line of English text, where T is the maximum context length. Byte-level byte-pair encoding (BBPE) is used to generate the vocabulary used by the neural transformer model with attention. A text string of natural language text is represented as a sequence of Unicode Transform Format, UTF-8 bytes. The input text string of subtokens is encoded as a sequence of UTF-8 bytes, where a subtoken is encoded into one to four bytes. A byte sequence is then partitioned into byte-level subwords, referred to as byte n-grams. (Collectively, block 408).

The byte-level subwords are generated using the Byte Pair Encoding (BPE) component, which extracts the k most frequently-occurring n-grams. The result is a vocabulary size of the k most frequently-occurring n-grams. An n-gram is a contiguous sequence of n subtokens from an input text string of either source code or natural language text. This type of encoding does not rely on knowing the underlying language making it suitable for an input sequence of text strings that contain source code or natural language text. The ordered sequences of UTF-8 bytes are translated into a T-ordered sequence of subtokens which are vector representations of a natural language text segment. The T-ordered sequence of subtokens is transformed into a context vector. (Collectively, block 408).

A denoising function, such as a span masking function, is then applied to each sequence that randomly masks out a subset of subtokens and the masked span of subtokens is replaced with a mask subtoken, M. The model is trained with the masked sequences to learn to reconstruct the original sequence without the masked subtokens. In one aspect, the mask subtoken replaces a span of subtokens. The number of text spans and the span lengths are randomly generated and each span is replaced with a single mask subtoken. (Collectively, block 408).

The masked denoising is based on the doze task of evaluating human language-learners' proficiency, in which humans are given a foreign language with missing words, and are asked to correctly choose the missing word. The benefit of span-masking denoising in pre-training is that the model learns the desired language in an unsupervised fashion, but also is bi-directional in the sense that it learns the relationships of words both before and after their occurrence. (Collectively, block 408).

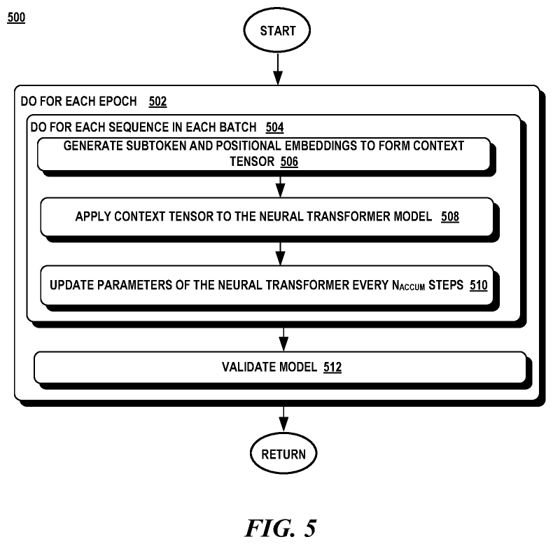

Each of the input sequences is transformed into an embedding and applied to the neural transformer model (block 408). Turning to FIG. 5, there is shown an exemplary process 500 for applying a training dataset to the neural transformer. Neural transformer models are trained iteratively, making multiple passes over the training dataset before converging to a minimum. An epoch represents the entire training dataset passed forwards and backwards through the neural transformer block once. Since the training dataset is very large, it is partitioned into smaller batches. The training is iterative and the entire dataset is passed through the neural transformer in multiple iterations. Each training iteration includes forward propagation, loss calculation, backpropagation steps followed by updating the weights. The training dataset is partitioned into batches with each batch of sequences running through the training process.

The neural transformer model has multiple blocks and layers so that more detailed relationships within the data are learned as well as how the features interact with each other on a non-linear level. The model architecture, training procedure, data normalization and vocabulary encoding procedures are hyperparameters that are tailored to meet a particular objective. The values of the hyperparameters influence how the parameters are learned.

In one aspect, the hyperparameters may include the following: (1) subtoken and position embedding layers of dimensions: 50000×1024, and 1024×1024 respectively; (2) the configuration of the neural transformer model with twelve encoder blocks and twelve decoder blocks; (3) for the training procedure: denoising auto-encoder, with a cross-entropy loss optimization objective; the sequence length of 1024 symbols; a mini-batch size of 8; the gradient accumulation steps for each weight update is 8; the Adam stochastic optimization procedure is used to train the feed-forward neural network; and the learning rate is 0.0001; and (4) the vocabulary encoding procedure: byte-level byte-pair encoding.

For each sequence of each batch in each epoch (blocks 502, 504), the T-ordered sequences of subtokens are then mapped into numeric vectors and then into respective subtoken embeddings and positional embeddings (block 506). An embedding is a learned representation for the text-based subtokens where subtokens that have a common meaning have a common representation. An embedding is a mapping of discrete categorical variables to a vector of continuous numbers. There is an embedding for each subtoken in the vocabulary of a particular programming language and a corresponding positional embedding. The subtoken embedding represents the learned representation for the subtoken. The neural transformer model does not read each subtoken sequentially and as such, has no knowledge of the subtoken's position in a sequence without additional position information. The positional embedding is used to encode position information about a subtoken's position in a sequence into the neural transformer model.

Initial values are generated for the subtoken embedding and positional embeddings of each sequence which are then used to form a context tensor. Thereafter, the neural transformer model learns the values for each embedding. Upon the completion of the training phase, the embeddings for each subtoken and the positional embeddings are saved into respective matrices for later use. There is a subtoken embedding matrix, We, that contains an embedding vector for each subtoken tᵢ, i=0 . . . V of a particular programming language, and a positional embedding matrix, Wp, that contains an embedding vector Pⱼ, j=0 . . . T, for each position, where V is the size of the vocabulary for a particular programming language and T is the length of the subtoken sequence. (Collectively, block 506).

The first encoder block 202 of the neural transformer model 200 takes the context tensor 209 as input and passes it through the multiple layers of multi-head attention, layer normalization and feed-forward neural network to finally produce a set of hidden representations If there are additional encoder blocks, the output of each encoder block is passed onto the next encoder block with the output of the last encoder block producing the set of hidden representations 217. The set of hidden representations is passed onto each decoder block 204. (Collectively, block 508).

The softmax layer 226 generates output probabilities of each token in the model vocabulary which is used to predict the tokens to replace the masked tokens (block 508).

The decoder blocks 204 of the pre-trained neural transformer model takes a shifted sequence of an output embedding as input. The masking in the masked multi-head attention layer is used to prevent positions from attending to subsequent positions in the future. The masking combined with the output embeddings shifted by one position ensures that the predictions to position T depend only on the known outputs at positions less than T. Starting with the first token of the output sequence, the subtokens are passed through the self-attention and normalization layers and into the encoder-decoder attention layer, serving as the query for encoder-decoder attention, where the key and value pairs for the attention are the outputs of encoder. The encoder output was calculated with the entire input embedding sequence. (Collectively, block 508).

The feed-forward neural networks in the encoder blocks 202 and the decoder blocks 204 are trained iteratively, making multiple passes over the training dataset before converging to a minimum. Each training iteration includes forward propagation, loss calculation, backpropagation steps followed by updating the weights by calculating the weight gradients. The loss function estimates the loss or error which is used to compare how good or bad the predicted results are. In one aspect, a cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 508).

At the completion of each batch, the parameters of the neural transformer model are updated at a preconfigured frequency denoted as Naccum. Naccum is a gradient accumulation frequency and in one aspect has a value of 8. The parameters include the subtoken embeddings and the positional embeddings which are stored in a respective embedding matrix. (Collectively, block 510).

Next, the neural transformer model is validated. Before the neural transformer model is trained, a set of hyperparameters is selected randomly and then tuned to achieve a desired performance. The neural transformer model is tested using a validation dataset to determine the appropriate hyperparameters settings to achieve a desired goal. When the desired goal is not achieved, one or more hyperparameters are adjusted and the training is repeated until the target goal is achieved. Perplexity on the validation set is calculated to validate the performance of the model with respect to the learning the masked out original text. (Collectively, block 512).

Turning back to FIG. 4, the neural transformer model is then fine-tuned with method generation tasks that include either the intent-snippet pairs or the method templates. The sequences of the method generation tasks include a tuple including natural language text (e.g., intent or docstring), method signature, and method body) are parsed into a concrete syntax tree from which ordered sequence of tokens are extracted. Byte-pair encoding is used to split the tokens into subtokens, if possible, and the resulting ordered sequence is used to train the neural transformer model in a same manner as described above with respect to FIG. 5 (Collectively, block 410).

Inference Phase

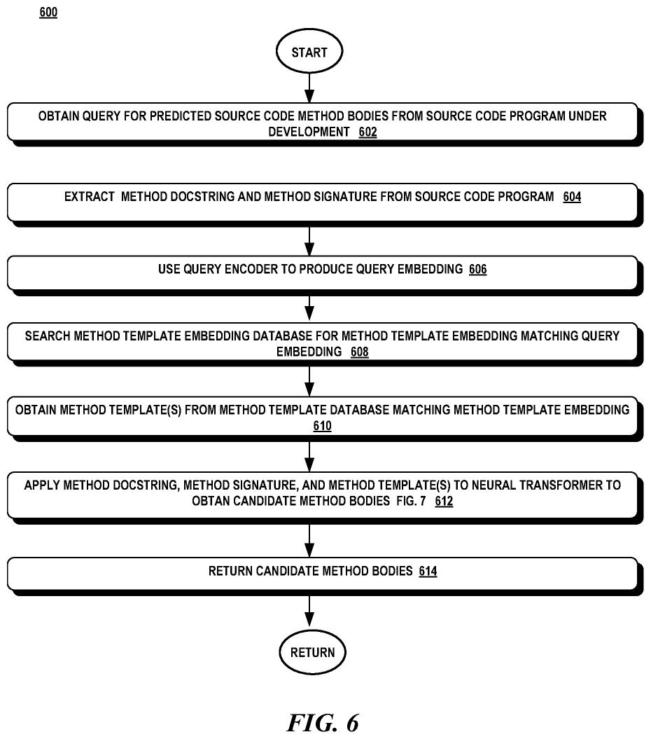

FIG. 6 illustrates an exemplary method 600 of applying the neural transformer model with attention to predict a candidate method body. A query is obtained from a program under development (block 602). In one aspect, the query includes the method docstring. The method docstring and the method signature are extracted from the program under development (block 604).

The query encoder generates an embedding of the query (block 606). The code search engine 110 searches the method template embedding database for a closest-matching method template embedding for the query embedding (block 608). In one aspect, a nearest neighbor approximation technique is used to find the closest-matching method template embedding (block 608).

In one aspect, the Approximate Nearest Neighbor (“ANNOY”) technique is used to find the closest matching method templates to a query using the respective query embedding and method template embeddings. ANNOY works by partitioning the entire vector space into subspaces through constant random projections and performs a nearest neighbor search in the lower-dimensional subspaces.

The method template embedding is then used to obtain one or more matching method templates from the method template database (block 610). The method templates, method docstring and the method signature are then applied to the neural transformer model to obtain candidate method bodies (block 612). The candidate method bodies are then returned to the source code program (block 614).

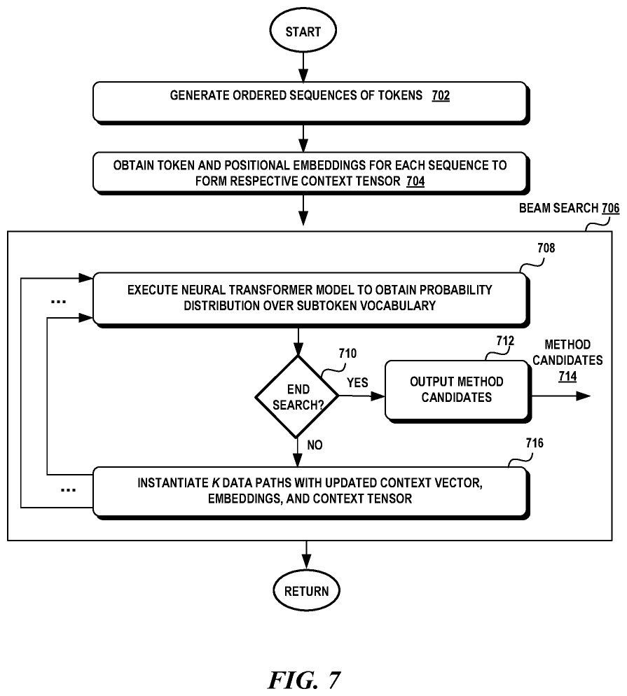

Turning to FIG. 7, there is shown a process 700 for predicting candidate method bodies for a query. The decoder's computation at training time may be parallelized using masked self-attention but during inference, the subtokens are generated one token at a time. The neural transformer model factorizes the probability of the target subtokens in an input sequence into a product of conditional probabilities for each subtoken using the formula: p (t₁, tₘ|s)=Πᵢ₌₁^{m}p(tᵢ|t₁, . . . , tᵢ₋₁, s). During inference, the calculation of the product of the conditional probabilities for each subtoken is complex and extremely time consuming making the model difficult for real-time applications. Beam search is an approximation algorithm that performs faster.

The beam search uses the probability distribution generated by the neural transformer model to identify the top k subtokens likely to be the next subtoken in a method candidate. The beam search expands the search by instantiating new partial sequences using each of the selected subtokens identified by the neural transformer model's probability distribution. The search continues generating new partial sequences from the top k subtokens identified by the output distributions until the search ends. The search may end when the end-of-method token appears as the most probable next subtoken.

A beam search uses a breadth-first search to build a search tree. The search tree is composed of nodes at one or more inference levels. Each node represents a probability distribution generated by the neural transformer model for the subtokens in the model vocabulary. At each level, only the top k subtokens having the highest probabilities from the output distribution generated by the neural transformer model are expanded to the next inference level. The variable k is preconfigured and referred to as the beam width. Each of the k subtokens is then expanded into a search that updates the current translation candidate sequence with the selected subtoken to input into the neural transformer model to generate an additional probability distribution for the next subtoken in a sequence. This process is repeated until the toss end-of-method token appears as the most probable next subtoken or the maximum length threshold is exceeded.

The method docstring, method signature, and the method templates are transformed into ordered sequences of tokens (block 702). Each of the inputs is parsed into a concrete syntax tree, tokenized and split into subtokens via byte-pair encoding (block 702). Each sequence of tokens is transformed into a sequence of token and positional embeddings and then transformed into a context tensor (block 704).

The beam search 706 uses the neural transformer model with the context tensor to generate a probability distribution for the subtoken vocabulary at each decoder time step (block 708). If the probability distribution indicates that the next likely token is the end-of-method token, then the beam search is finished (block 710—yes) and the method candidates 714 are output (block 712). Otherwise (block 710—no), the top k subtokens to complete a partial sequence are selected (block 716).

Each of the selected subtokens is then input in a respective context vector and has a separate data path through the neural transformer model again. The context vector utilizes the selected subtoken in the current context vector with the last subtoken removed. The new context vector will consist of T subtokens with the selected subtoken t₀ added to the beginning of the sequence with the last subtoken removed from the sequence. If the current context vector consists of a subtoken sequence consisting of t₀, t₁, . . . , t_{T}. then the new context vector will consist of tₖ, t₀, t₁, . . . , t_{T-1}. (Collectively, block 716).

Source Code Completion

Attention how turns to a discussion of an exemplary embodiment of the source code generation system. In one aspect, the source code generation system is embodied in a source code completion system. Source code completion is a feature in which an application predicts the rest of a fragment of code that a user is typing. Source code completion may be a function or feature integrated into a source code editor and/or integrated development environment (IDE). Source code completion may be embodied as an add-on, plug-in, extension and/or component of a source code editor and/or IDE. Examples of source code completion systems include, without limitation, Microsoft's IntelliSense, Jetbrain's Intellij IDEA, Eclipse Code Recommenders, and the like.

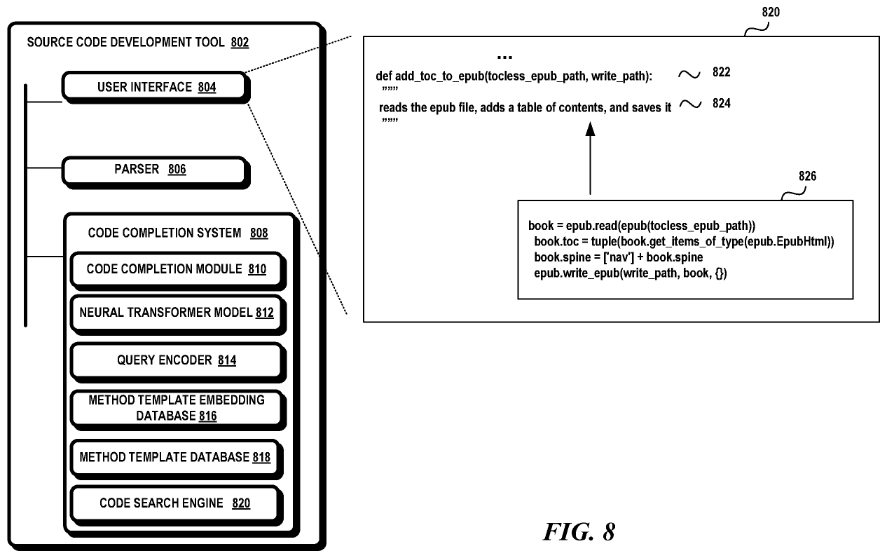

Turning to FIG. 8, there is shown a source code development tool 802 embodying the source code generation system. The source code development tool 802 includes a user interface 804, a parser 806, and a code completion system 808. The code completion system 808 includes a code completion module 810, a neural transformer model 812, a query encoder 814, a method template embedding database 816, a method template database 818, and a code search engine 820.

The user interface 804 includes a set of features or functions for writing and editing a source code program. The user interface 804 may utilize a pop-up window to present a list of possible candidates for completion thereby allowing a developer to browse through the candidates and to select one from the list. In this manner, code completion serves as documentation of the possible method bodies to complete a method docstring and/or method signature in addition to being an assistance to writing code quickly.

The parser 806 reads the source code and generates a corresponding syntax tree. The parser 806 also updates the syntax tree as the developer creates and edits the source code.

At certain points in the editing process, the user interface 804 will detect that the user has entered a particular character which will initiate code completion. In one aspect, when the user presses predefined key strokes, such as ‘Ctrl+Space’, a list of recommendations appear. Alternatively, the recommendation list will appear as soon as the user starts typing a method signature.

The user interface 804 will then request candidates from the code completion system 808 to present in the user interface 802 for a particular method signature and method docstring. The query encoder 814 uses the method docstring to generate an embedding which is used by the code search engine 820 to find a matching method template embedding from the method template embedding database 816. The method template embedding is then used to find one or more method templates from the method template database 818. The one or more method templates, method docstring, and method signature are then applied to the neural transformer model 812 which generates candidate method bodies.

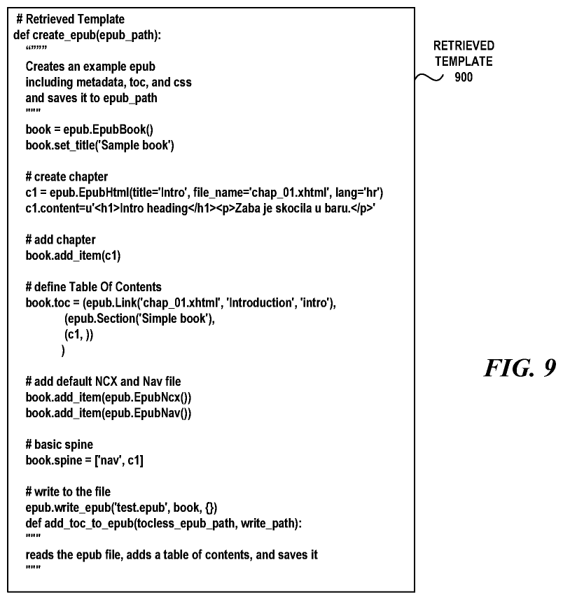

As shown in FIG. 8, a partial source code program written in the Python programming language 820 is input into the user interface. The partial program includes a method signature 822 and a method docstring 824. The code completion system 808 generates a candidate method body to complete the method 826. This candidate method body was based on the retrieved method template 900 shown in FIG. 9.

Exemplary Operating Environment

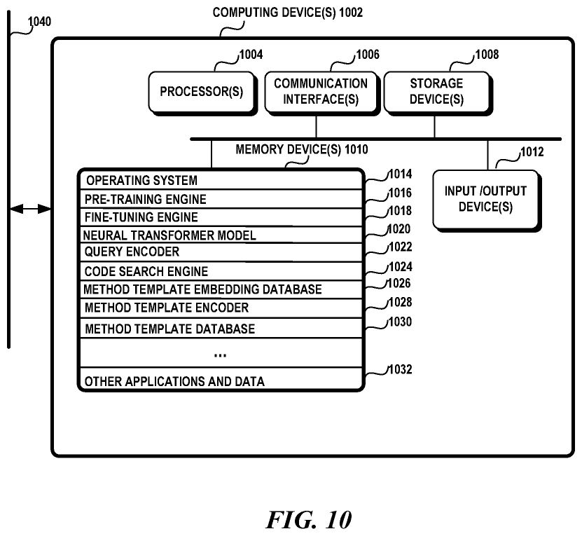

Attention now turns to a discussion of an exemplary operating environment. FIG. 10 illustrates an exemplary operating environment 1000 in which one or more computing devices 1002 are used to train and utilize the neural transformer model for program repair. However, it should be noted that the aspects disclosed herein is not constrained to any particular configuration of devices. Computing devices 1002 may be configured as a cloud service that generates the neural transformer model as a service and/or offers the repair generation engine with the neural transformer model for program repair. It should be noted that the operating environment is not limited to any particular configuration and other configurations are possible.

A computing device 1002 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 1000 may be configured in a network environment, a distributed environment, a multi-processor environment, or a stand-alone computing device having access to remote or local storage devices.

The computing device 1002 may include one or more processors 1004, one or more communication interfaces 1006, one or more storage devices 1008, one or more input/output devices 1012, and one or more memory devices 1010. A processor 1004 may be any commercially available or customized processor and may include dual microprocessors and multi-processor architectures. A communication interface 1006 facilitates wired or wireless communications between the computing device 1002 and other devices. A storage device 1008 may be computer-readable medium that does not contain propagating signals, such as modulated data signals transmitted through a carrier wave. Examples of a storage device 1008 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 1008 in the computing device 1002. The input/output devices 1012 may include a keyboard, mouse, pen, voice input device, touch input device, display, speakers, printers, etc., and any combination thereof.

A memory device or memory 1010 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory 710 may also include one or more external storage devices or remotely located storage devices that do not pertain to propagated signals, such as modulated data signals transmitted through a carrier wave.

The memory device 1010 may contain instructions, components, and data. A component is a software program that performs a specific function and is otherwise known as a module, program, component, and/or application. The memory device 1010 may include an operating system 1014, a pre-training engine 1016, a fine-tuning engine 1018, neural transformer model 1020, query encoder 1022, code search engine 1024, method template embedding database 1026, method template encoder 1028, method template database 1030, and other applications and data 1032.

The computing devices 1002 may be communicatively coupled via a network 1040. The network 1040 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 1040 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

A system comprises one or more processors and a memory. The memory stores one or more programs that are configured to be executed by the one or more processors. The one or more programs including instructions to perform acts that: obtains a natural language query for a method body from a source code program under development; searches a method template database for one or more method templates closely-matching the query; and uses a deep learning model to predict a candidate method body given the natural language query, a method signature associated with the natural language query, and the one or more method templates.

In an aspect, the method template database is indexed by a method template embedding. In an aspect, the one or more programs include further instructions to perform acts that: generates an embedding for the natural language query; and searches for method template embeddings closely-matching the embedding of the natural language query. In an aspect, the one or more programs include further instructions to perform acts that: searches the method template database using the method template embeddings for the one or more method templates closely-matching the embedding of the natural language query.

In an aspect, the one or more programs include further instructions to perform acts that: employs a method template encoder to generate method template embeddings and a query encoder to generate query embeddings, wherein the method template embeddings and the query embeddings share a joint embedding space. In an aspect, the deep learning model is trained on natural language and source code of a programming language of the source code program. In an aspect, the deep learning model is trained on tuples including a natural language query associated with a method, a method signature of the method and a method body of the method. In an aspect, the deep learning model is a neural transformer model with attention. In an aspect, the natural language query is a method docstring.

A method is disclosed that is performed on a computing device having a processor and a memory, the method, comprising: pre-training a deep learning model on natural language text and source code of a programming language; and fine-tuning the deep learning model on method generation tasks, a method generation task including a method docstring, a method signature, and a method body of a same method, wherein fine-tuning the deep learning model trains the deep learning model to learn to predict a target method body given a target method signature, a target method docstring and one or more pre-existing method templates closely-matching the target method docstring.

In an aspect, the method further comprises generating sequences of tokens from the natural language text and source code of the programming language using a span masking function. In an aspect, the method further comprises: jointly training a query encoder and a method template encoder, wherein the query encoder generates a query embedding for a method docstring and the method template encoder generates a method template embedding for a method template, wherein the query embeddings and the method template embeddings share a joint embedding space.

In an aspect, the method further comprises: generating a method embedding template database, the method embedding template database including the method template embeddings. In an aspect, the method further comprises: generating a method template database including a plurality of method templates, a method template of the plurality of method templates indexed by a respective method template embedding. In an aspect, the joint training the query encoder and the method template encoder is performed by a neural Bag-of-Words bi-encoder. In an aspect, the deep learning model is a neural transformer with attention.

A device is disclosed comprising a processor and a memory. The processor is configured to execute instruction to perform acts that: extracts a method docstring and a method signature from a source code program in a source code editor, wherein the method signature lacks a method body; obtains at least one method template associated with the method docstring; invokes a neural transformer model with attention to predict a method body given the method docstring, method signature and the at least one method template; and provides the method body to the source code program.

In an aspect, the processor is configured to execute further instructions that: generates an embedding for the method docstring; and searches a method template embedding database for a method template embedding closely-matching the embedding for the method docstring. In an aspect, the processor is configured to execute further instructions that: searches a method template database for the at least one method template based on the closely-matching method template embedding. In an aspect, the neural transformer model with attention is trained on natural language text and source code methods of a programming language of the source code program. In an aspect, the method template embeddings and the method docstring embeddings share a joint embedding space.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system comprising:
one or more processors; and
a memory that stores one or more programs that are configured to be executed by the one or more processors, the one or more programs including instructions to perform acts that:
obtains a natural language query for a method body from a source code program under development;
searches a method template database for one or more method templates closely-matching the query; and
uses a deep learning model to predict a candidate method body given the natural language query, a method signature associated with the natural language query, and the one or more method templates.

2. The system of claim 1, wherein the method template database is indexed by a method template embedding.

3. The system of claim 2, wherein the one or more programs include further instructions to perform acts that:
generates an embedding for the natural language query; and
searches for method template embeddings closely-matching the embedding of the natural language query.

3. The system of claim 2, wherein the one or more programs include further instructions to perform acts that:
searches the method template database using the method template embeddings for the one or more method templates closely-matching the embedding of the natural language query.

4. The system of claim 3, wherein the one or more programs include further instructions to perform acts that:
employs a method template encoder to generate method template embeddings and a query encoder to generate query embeddings, wherein the method template embeddings and the query embeddings share a joint embedding space.

5. The system of claim 1, wherein the deep learning model is trained on natural language and source code of a programming language of the source code program.

6. The system of claim 5, wherein the deep learning model is trained on tuples including a natural language query associated with a method, a method signature of the method and a method body of the method.

7. The system of claim 1, wherein the deep learning model is a neural transformer model with attention.

8. The system of claim 1, wherein the natural language query is a method docstring.

9. A method performed on a computing device having a processor and a memory, the method, comprising:
pre-training a deep learning model on natural language text and source code methods of a programming language; and
fine-tuning the deep learning model on method generation tasks, a method generation task including a method docstring, a method signature, and a method body of a same method,
wherein fine-tuning the deep learning model trains the deep learning model to learn to predict a target method body given a target method signature, a target method docstring and one or more pre-existing method templates closely matching the target method docstring.

10. The method of claim 9, further comprising:
generating sequences of tokens from the natural language text and source code methods of the programming language using a span masking function.

11. The method of claim 9, further comprising:
jointly training a query encoder and a method template encoder, wherein the query encoder generates a query embedding for a method docstring and the method template encoder generates a method template embedding for a method template, wherein the query embeddings and the method template embeddings share a joint embedding space.

12. The method of claim 11, further comprising:
generating a method embedding template database, the method embedding template database including the method template embeddings.

13. The method of claim 12, further comprising:
generating a method template database including a plurality of pre-existing method templates, a pre-existing method template of the plurality of pre-existing method templates indexed by a respective method template embedding.

14. The method of claim 11, wherein jointly training the query encoder and the method template encoder is performed by a neural Bag-of-Words bi-encoder.

15. The method of claim 10, wherein the deep learning model is a neural transformer with attention.

16. A device, comprising:
a processor and a memory;
wherein the processor is configured to execute instruction to perform acts that:
extracts a method docstring and a method signature of a method from a source code program in a source code editor, wherein the method lacks a method body;
obtains at least one method template associated with the method docstring;
invokes a neural transformer model with attention to predict a method body given the method docstring, method signature and the at least one method template; and
provides the method body to the source code program.

17. The device of claim 16, wherein the processor is configured to execute further instructions that:
generates an embedding for the method docstring; and
searches a method template embedding database for a method template embedding closely-matching the embedding for the method docstring.

18. The device of claim 17, wherein the processor is configured to execute further instructions that:
searches a method template database for the at least one method template based on the closely-matching method template embedding.

19. The device of claim 16, wherein the neural transformer model with attention is trained on natural language text and source code methods of a programming language of the source code program.

20. The device of claim 17, wherein the method template embeddings and the method docstring embeddings share a joint embedding space.
